(19) United States
(12) Patent Application Publication
(10) Pub. No.: US 2022/0082141 A1
(43) Pub. Date: Mar. 17, 2022

(54) CLUTCH FOR DOOR LOCK

(71) Applicant: ASSA ABLOY Residential Group, Inc., New Haven, CT (US)

(72) Inventors: Shannon Petty, San Francisco, CA (US); Aaron Treger, Pinole, CA (US)

(73) Assignee: ASSA ABLOY Residential Group, Inc., New Haven, CT (US)

(21) Appl. No.: 17/475,061

(22) Filed: Sep. 14, 2021

Related U.S. Application Data
(60) Provisional application No. 63/079,974, filed on Sep. 17, 2020.

(51) Int. Cl. F16D 41/066; E05B 63/00; E05B 47/00

(52) U.S. Cl. CPC F16D 41/066; E05B 63/0017; E05B 47/0012; E05B 2047/0027; E05B 2047/002; E05B 2047/0024; E05B 2047/0017

(57) ABSTRACT

In some embodiments, a clutch for a door lock may include an output gear including a plurality of inner detents and a lag plate rotatable relative to the output gear and configured to generate friction when the lag plate rotates. The clutch may also include an input cam configured to be coupled to an output shaft of an actuator, where the input cam is configured to switch between an engaged state and a disengaged state. The clutch may also include a ball bearing configured to engage one of the plurality of inner detents when the input cam is in the engaged state. The ball bearing may also be configured to disengage from the plurality of inner detents under frictional force generated by the lag plate when the input cam is in the disengaged state and the output gear is rotated by an external force.

### RELATED APPLICATIONS

This application claims the benefit under 35 U.S.C. § 119(e) of U.S. Provisional Application Ser. No. 63/079,974, filed Sep. 17, 2020, the disclosure of which is incorporated herein by reference in its entirety.

### FIELD

Some disclosed embodiments are related to a clutch for a door lock and related methods of use. The clutch may allow powered rotation or unpowered rotation of an output gear in two directions. In some embodiments, a cam associated with an actuator may be employed to selectively engage one or more ball bearings with one or more corresponding internal detents of the output gear to couple the actuator to the output gear for powered rotation.

### BACKGROUND

Deadbolt locks may be used to secure doors to prevent unauthorized entry. Some deadbolt locks can be operated manually by a knob, thumb-turn, or other handle mounted on a secured side of the door, and by a key on an unsecured side of the door. For such deadbolt locks, rotation of the handle extends or retracts a deadbolt into or out of the door. Some deadbolts may be electromechanically actuatable in addition to being manually actuatable. Such electromechanical deadbolts may include a motor that may extend or retract the bolt.

### SUMMARY

In some embodiments, there is provided a clutch for a door lock including an output gear including a plurality of inner detents, a lag plate rotatable relative to the output gear and configured to generate a friction when the lag plate rotates, and an input cam configured to be coupled to an output shaft of an actuator, where the input cam is configured to switch between an engaged state and a disengaged state. The clutch also includes a ball bearing configured to when the input cam is in the engaged state, engage one of the plurality of inner detents to operatively couple the input cam to the output gear, and when the input cam is in the disengaged state and the output gear is rotated by an external force, disengage from the plurality of inner detents under frictional force generated by the lag plate.

In some embodiments, there is provided a door lock including a housing, a deadbolt lock configured to move between a retracted position and an extended position, a deadbolt lock handle operatively coupled to the deadbolt lock so that the deadbolt lock handle may be rotated to move the deadbolt lock between the retracted position and the extended position, and an output gear including a plurality of inner detents, where the output gear is operatively coupled to the deadbolt lock handle such that rotation of the output gear rotates the deadbolt lock handle. The door lock also includes an actuator including an output shaft and a lag plate rotatable relative to the output gear and housing, where the lag plate is configured to generate frictional force when the lag plate rotates relative to the housing. The door lock also includes an input cam configured to be coupled to the output shaft of the actuator, where the input cam is configured to switch between an engaged state and a disengaged state, and a ball bearing configured in the clutch to when the input cam is in the engaged state, engage one of the plurality of inner detents to operatively couple the input cam to the output gear, and when the input cam is in the disengaged state and the output gear is rotated by an external force, disengage from the plurality of inner detents under frictional force generated by the lag plate.

In some embodiments, there is provided a method of operating a door lock including rotating an input cam in a first direction from a disengaged state to an engaged state, where rotating the input cam from the disengaged state to the engaged state moves a ball bearing into one of a plurality of inner detents of an output gear. The method also includes rotating the input cam in the first direction to correspondingly rotate the output gear in the first direction, and rotating the input cam in a second direction opposite the first direction to move the input cam from the engaged state to the disengaged state, where moving the input cam to the disengaged state allows the ball bearing to disengage from the plurality of inner detents.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings.

FIG. 1A is a front perspective view of one embodiment of a clutch;

FIG. 1B is a rear perspective view of the clutch of FIG. 1A;

FIG. 1C is a front perspective cross-sectional view of the clutch of FIG. 1A taken along line 1C-1C in FIG. 1A;

FIG. 2A is a front cross-sectional view of the clutch of FIG. 1C in a first state;

FIG. 2B is a front cross-sectional view of the clutch of FIG. 2A in a second state;

FIG. 2C is a front cross-sectional view of the clutch of FIG. 2A in a third state;

FIG. 2D is a front cross-sectional view of the clutch of FIG. 2A in a fourth state;

FIG. 2E is a front cross-sectional view of the clutch of FIG. 2A in a fifth state;

FIG. 2F is a front cross-sectional view of the clutch of FIG. 2A in a sixth state;

FIG. 3 is a flow chart for one embodiment of a method of operating a clutch according to some exemplary embodiments described herein;

FIG. 4 is a flow chart for one embodiment of a method of manufacture for a clutch according to some exemplary embodiments described herein; and

FIG. 5 is a perspective view of one embodiment of a door lock including a clutch.

### DETAILED DESCRIPTION

Traditionally, doors often employ deadbolt locks (also referred to simply as deadbolts) including a bolt that in a retracted (e.g., unlocked) position is disposed at least partially within a door and in an extended (e.g., locked) position extends out from the door, such as into a doorjamb of a door frame. The physical presence of the bolt extending from within the door into the doorjamb inhibits the door from being opened by blocking the door from being swung out of the door frame. Such deadbolt locks may include actuators to move a bolt of the lock between the extended position and/or the retracted position.

Such deadbolt locks may employ one or more rotating shafts that rotate as part of driving the extension or retraction of the bolt of the door lock, when manually operated or when operated by the actuator. As the rotating shaft rotates, the bolt is driven along its linear path of travel between the retracted position and/or the extended position. The rotating shaft may be operatively coupled to the actuator and the actuator may be configured to apply force to the driveshaft in two rotational directions to either extend or retract the bolt. In some cases, a handle is also coupled to the driveshaft and is configured to allow for manual movement of the bolt between the extended and retracted positions.

The inventors recognized that, if both the actuator and the handle are coupled to the rotating shaft, operation of the handle may apply a force to the actuator or the actuator may resist movement of the handle. The inventors therefore recognized the advantage that would be provided by a clutch to decouple an actuator or a handle from a rotating shaft, such that, for example, when the handle is operated, the actuator may be decoupled from the driveshaft.

The inventors also recognized, however, that there are disadvantages to existing clutches. Conventionally-available clutches could be integrated into a lock for such a purpose and selectively decouple an actuator from a rotating shaft, but such conventionally-available clutches would allow powered rotation in only a single rotational direction. This means the actuator would not be able to drive the bolt in an extending/lock direction and in a retracting/unlocking direction. This would be disadvantageous for an electrified lock with an actuator, as it would limit the utility of the lock.

In view of the above, the inventors have recognized the benefits of a clutch for a door lock that selectively decouples an actuator from an output shaft or gear of the door lock. In particular, the inventors have recognized the benefits of a clutch that allows an actuator to selectively engage and rotate the output shaft or gear in two directions. When the actuator is decoupled, a handle of the door lock may freely rotate the output shaft or gear without resistance from the actuator. The clutch may also have a small form factor relative to conventional clutches, as the clutch may fit into a form factor similar to the size of an output gear alone.

In some embodiments, a clutch for a door lock includes an output gear including a plurality of inner detents. The clutch also includes a lag plate rotatable relative to the output gear and configured to generate friction when the lag plate rotates. The lag plate may be at least partially disposed inside of the output gear and may be coaxial with the output gear. The clutch may also include an input cam configured to be coupled to an output shaft of an actuator of the door lock, where the input cam is configured to switch between an engaged state and a disengaged state. The input cam may be configured to selectively transfer force to the output gear in two rotational directions. The clutch may also include a ball bearing configured to engage one of the plurality of inner detents to operatively couple the input cam to the output gear when the input cam is moved to the engaged state. The ball bearing may be positioned between the input cam and the plurality of detents, such that moving the input cam to the engaged state moves the ball bearings outward relative to the input cam to engage the plurality of inner detents. When the input cam is moved to the disengaged state, the ball bearing may disengage from the plurality of inner detents when the output gear is rotated (e.g., manually by a handle) under a frictional force generated by the lag plate. In some embodiments, the lag plate may include a slot configured to receive the ball bearing when the input cam moves to the engaged state. Accordingly, when the lag plate is rotated, the lag plate may apply the frictional force to the ball bearing via the slot.

According to some exemplary embodiments described herein, an input cam may move between an engaged state and a disengaged state. The difference between the engaged state and the disengaged state may be an angular displacement of the input cam relative to the engaged state. The engaged state may be defined by a state in which the input cam is in contact with one or more ball bearings and the ball bearings are engaged with a plurality of inner detents of an output gear. From the engaged state, the disengaged state may be defined by a rotation of the input cam away from the one or more ball bearings. That is, if the input cam remains in contact with the one or more ball bearings when the input cam rotates in a first direction, movement to the disengaged state may include rotating the input cam in a second direction opposite the first direction.

The clutch may also, in some embodiments, operate in a similar way in the reverse direction. In these embodiments, the input cam remains in contact with the one or more ball bearings when the input cam is rotated in the second direction in the engaged state, and movement to the disengaged state includes rotating the input cam in the first direction opposite the second direction. In this manner, the clutch may be able to apply force through the clutch in two rotational directions.

The engaged state may correspond to a plurality of positions of the input cam. For example, in the engaged state the input cam may rotate continuously in one direction while remaining in the engaged state. Correspondingly, the disengaged state may also correspond to a plurality of positions of the input cam, where the disengaged state is a relative movement to the position of the input cam in the engaged state.

The amount of rotation of the input cam may be suitable such that the one or more ball bearings may disengage from the plurality of inner detents of the output gear. In some embodiments, the input cam may rotate by 90 degrees from the engaged state to the disengaged state. In some embodiments, the input cam may rotate between 45 and 90 degrees from the engaged state to the disengaged state. That is, the engaged state and disengaged state may be separate by an angular displacement between 45 and 90 degrees of rotation. Of course, any suitable angular displacement may separate the engaged state and disengaged state, as the present disclosure is not so limited.

According to some exemplary embodiments described herein, a clutch for a door lock includes one or more ball bearings. The one or more ball bearings may selectively couple an input cam associated with an actuator to an output gear. In some embodiments, the clutch may include two ball bearings, where the two ball bearings are disposed on opposite sides of the input cam. Correspondingly, the input cam may include two lobes, where each of the two lobes in configured to engage one of the two ball bearings. The two lobes may be mirrored across an axis of rotation of the input cam, such that force imparted to the two ball bearings is balanced across the axis of rotation. Of course, any suitable number of ball bearings may be employed in a clutch for a door lock, as the present disclosure is not so limited. In some embodiments the number of ball bearings employed in a clutch may match a number of lobes of an input cam of the clutch. The ball bearings and lobes may be evenly distributed circumferentially around an axis of rotation of the input cam such that torques applied to the lobes of the input cam are balanced.

In some embodiments, a door lock including clutch includes a housing and a deadbolt lock configured to move between a retracted position and an extended position. The door lock also includes a deadbolt lock handle operatively coupled to the deadbolt lock so that the deadbolt lock handle may be rotated (e.g., by a user) to move the deadbolt lock between the retracted position and the extended position. The door lock may also include an actuator having an output shaft coupled to a clutch according to exemplary embodiments described herein. In particular, the output shaft may be coupled to an input cam of the clutch. The housing may at least partially enclose the clutch and actuator. The handle may be positioned on an exterior of the housing. An output gear of the clutch may be coupled to the deadbolt lock and configured to move the bolt between the retracted position and the extended position. The output gear may also be coupled to the deadbolt handle, such that rotation of the output gear rotates the deadbolt handle. In some embodiments, the output gear may be continually coupled to the deadbolt handle, such that whenever the output gear rotates the deadbolt handle correspondingly rotates. In such an embodiment, when the actuator rotates the output gear the actuator may also rotate the deadbolt handle.

According to some exemplary embodiments described herein, a door lock includes an actuator configured to selectively rotate an output gear of a clutch to correspondingly move a bolt of the door lock between an extended position and retracted position. In some embodiments, the actuator may be a direct current motor. The motor may include an output shaft configured to rotate in two rotational directions. The output shaft may be coupled to an input cam of a clutch according to exemplary embodiments described herein, such that the motor may selectively engage the bolt. In some embodiments, movement of the input cam via the motor may be used to switch the input cam between an engaged state and a disengaged state. That is, through movement of the motor alone, the clutch of the door lock may be engaged or disengaged such that the motor does not resist movement of the bolt between the extended position and retracted position. Of course, while in some embodiments the actuator is a motor, in other embodiments any suitable actuator may be employed. For example, an actuator may be configured as a servo, stepper motor, brushless motor, or any other suitable actuator, as the present disclosure is not so limited.

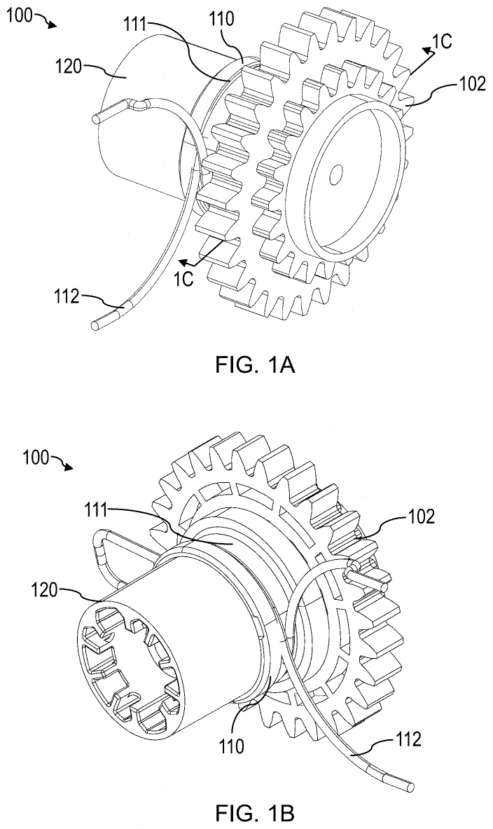

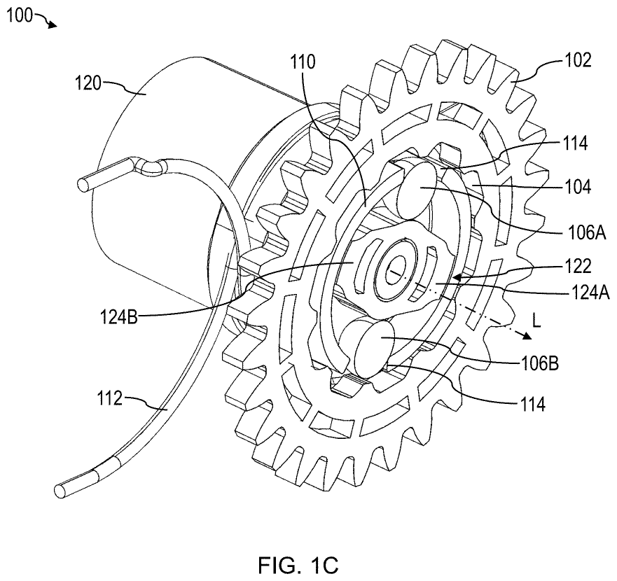

According to some exemplary embodiments described herein, a clutch for a door lock includes a lag plate configured to generate friction when the lag plate rotates. That is, the rotation of the lag plate may generation a friction force resisting the rotation of the lag plate. In some embodiments, the lag plate may be configured to rotate about a bushing or other rotational coupler that generates a frictional force above a threshold when the lag plate rotates. In some embodiments, the lag plate may include a brake or other friction generating element configured to apply friction to the lag plate when the lag plate rotates. In some embodiments, the lag plate may include a clamping spring attached to an exterior surface of the lag plate. The clamping spring may be attached at a first portion to a housing of the door lock, and at a second portion the clamping spring may apply a compression force against the lag plate. Accordingly, the clamping spring applies frictional force to the lag plate, such that when the lag plate rotates the first portion of the clamping spring stays stationary and the second portion of the clamping spring applies frictional force to the lag plate. Of course, any suitable brake or friction applying element, such as a spring, may be employed, as the present disclosure is not so limited. For example, in some embodiments a spring may apply a biasing force to drive a surface of a friction applying element into a surface of the lag plate. In some embodiments, the spring itself may be the friction applying element, and may apply a biasing force driving a surface of the spring into a surface of the lag plate (for example, see FIGS. 1A-1B). The lag plate may be configured to transfer the frictional force to one or more ball bearings of the clutch. The frictional force may be employed to move the one or more ball bearings out of engagement with an output gear of the clutch so that the output gear may rotate freely.

According to exemplary embodiments described herein, a door lock may add electromechanical drive capabilities for an associated deadbolt. That is, the door lock may be retrofittable to existing lock sets so consumers who desire remote or automatic actuation capabilities could add such capabilities without extensive modification of their existing doors.

In some embodiments, a method of operating a door lock includes rotating an input cam in a first direction from a disengaged state to an engaged state, where rotating the input cam from the disengaged state to the engaged state moves a ball bearing into one of a plurality of inner detents of an output gear. As the input cam is rotated from the disengaged state to the engaged state, a lobe of the input cam may urge the ball bearing outward relative to the input cam, where the ball bearing is disposed between the input cam and the output gear. The method may also include rotating the input cam in the first direction to correspondingly rotate the output gear in the first direction. Force between the input cam and the output gear may be transferred through the ball bearing engaged with the plurality of inner detents. In some embodiments, rotation of the output gear with the input cam may also rotate a lag plate of the door lock in the first direction. The method may also include rotating the input cam in a second direction opposite the first direction to move the input cam from the engaged state to the disengaged state. Moving the input cam to the disengaged state may allow the ball bearing to disengage from the plurality of inner detents. In some embodiments, the method may further include rotating the output gear with a deadbolt lock handle, where rotating the output gear while the input cam is in the disengaged state applied a frictional force to the ball bearing with the lag plate to urge the ball bearing out of the plurality of inner detents. In some embodiments, the method may be reversed such that the input cam is rotated in the second direction to switch into the engaged state and rotated in the first direction to switch into the disengaged state.

In some embodiments, a method of manufacture of a door lock includes rotatably coupling an output gear and a lag plate, where the lag plate and output gear are selectively rotatable relative to one another. The method may also include connecting the lag plate to a friction element that resists rotation of the lag plate. For example, the friction element may be a spring configured to apply a force to an external surface of the lag plate. In some embodiments, the spring may be wrapped around a circumference of the lag plate and configured to apply a compression force to the lag plate. The method may also include placing an input cam inside of the lag plate and the output gear, where the input cam is coaxial with the output gear and the lag plate. The method may also include placing a ball bearing between the input cam and the output gear, where the input cam is configured to selectively move the ball bearing to engage one of a plurality of inner detents of the output gear when the input cam is rotated from a disengaged state to an engaged state.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

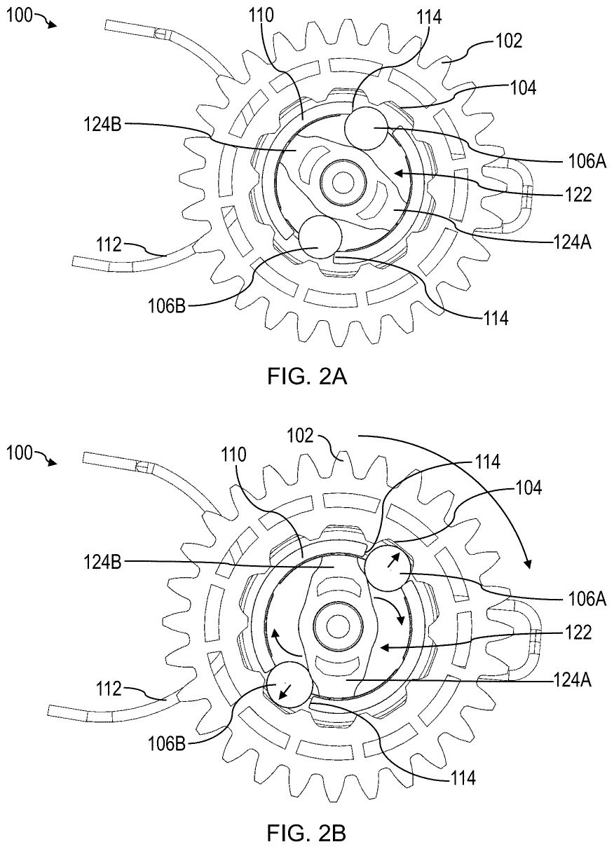

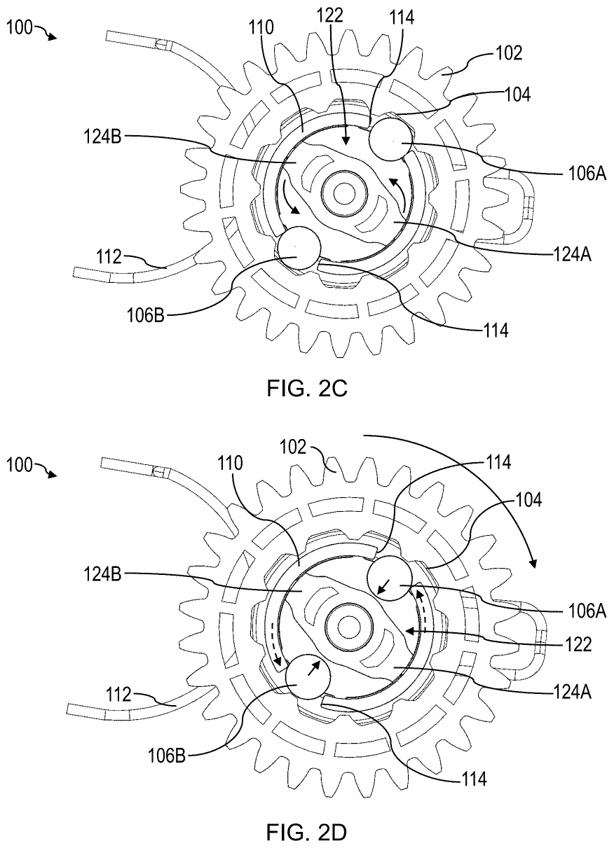

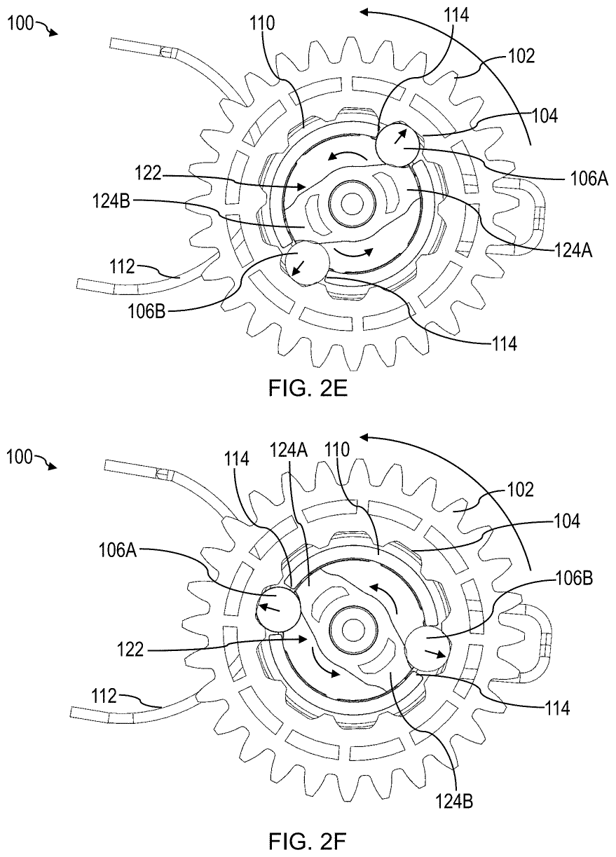

FIG. 1A is a front perspective view and FIG. 1B is a rear perspective view of one embodiment of a clutch 100 for use in a door lock. As shown in FIGS. 1A-1B, the clutch 100 includes an output gear 102. The output gear 102 is configured to be coupled directly or indirectly to a bolt of an associated door lock, where the output gear is rotatable to produce an output force that, when applied directly or indirectly (e.g., via one or more other gears, cams, or other mechanical elements) to a bolt, moves the bolt between an extended position and a retracted position. The output gear may also be coupled to a deadbolt handle of an associated door lock, where the deadbolt handle is manually operable to move the bolt between the extended position and the retracted position. The clutch 100 also includes a lag plate 110 which is rotatably coupled to the output gear 102. The lag plate includes a clamping spring 112 configured to apply a compression force to the lag plate. A first portion of the clamping spring 112 may be coupled to a housing of an associated door lock, such that a frictional force is generated by the lag plate when the lag plate is rotated. In the particular embodiment depicted in FIGS. 1A-1B, the clamping spring 112 is disposed in a spring channel 111 formed in an exterior surface of the lag plate 110. As shown in FIGS. 1A-1B, the clutch also includes a motor coupling 120. The motor coupling 120 is configured to couple a motor to an input cam positioned inside of the clutch 100. The functionality of the input cam and the clutch will be described further with reference to FIGS. 1C-2F.

FIG. 1C is a front perspective cross-sectional view of the clutch 100 of FIG. 1A taken along line 1C-1C in FIG. 1A, which reveals the internal components of the clutch. As shown in FIG. 1C, the clutch 100 also includes an input cam 122 disposed inside of both the lag plate 110 and the output gear 102, to receive and apply an input force to the ball bearings 106A, 106B that, in turn (as discussed below) drive the output gear 102 to generate the output force. The input force may be received from, for example, a motor or other actuator. The lag plate 110, output gear 102, and the input cam 122 are each coaxial with one another and selectively rotatable relative to one another. That is, each of the lag plate, output gear, and input cam share a longitudinal axis L.

As shown in FIG. 1C, the clutch also includes a first ball bearing 106A and a second ball bearing 106B. The first and second ball bearings are positioned on opposite sides of the input cam 122. The input cam 122 includes a first lobe 124A and a second lobe 124B which are each configured to engage one of the ball bearings. As shown in FIG. 1C, the output gear includes a plurality of inner detents 104. In particular, the embodiment of FIG. 1C includes 10 inner detents. Of course, in other embodiments any suitable number of detents may be employed, as the present disclosure is not so limited. Each of the inner detents is configured to engage with one of the first ball bearing 106A and second ball bearing 106B. The lag plate 110 includes two slots 114 configured to receive the first ball bearing 106A and the second ball bearing 106B.

As will be discussed further with reference to FIGS. 2A-2F, this arrangement shown in FIGS. 1A-1C allows the input cam 122 to selectively engage the output gear 102 to allow the motor to drive the output gear in two directions, to drive a bolt to an extended/locked position and to a retracted/unlocked position, while also allowing manual operation of a deadbolt handle to turn the output gear 102 without interface from the motor by permitting the input cam to disengage from the output gear 102.

FIG. 2A is a front cross-sectional view of the clutch 100 of FIG. 1C in a first state. In the state shown in FIG. 2A, the input cam 122 is in a disengaged state. Accordingly, the first ball bearing 106A and the second ball bearing 106B are not engaged with the plurality of inner detents 104. Accordingly, there is no linkage between the output gear 102 and the input cam 122. Likewise, the lag plate 110 does not interfere with the rotation of the output gear 102. Accordingly, the output gear 102 may be rotated (e.g., by a deadbolt handle) freely without resistance from the motor via the input cam 122.

FIG. 2B is a front cross-sectional view of the clutch 100 of FIG. 2A in a second state. In the state shown in FIG. 2B, the input cam has been rotated (e.g., via an input force from a motor or other actuator) in a first direction (e.g., clockwise relative to the page) to an engaged state. In the engaged state, the second lobe 124B of the input cam 122 is engaged with the first ball bearing 106A and the first lobe 124A of the input cam is engaged with the second ball bearing 106B. Due to the shape of the cam, this rotation urges each of the two ball bearings outward relative to the input cam. That is, the cam has a shape including an inclined surface relative to a radial line extending from the center of the input cam. The inclined surface generates a normal force against the ball bearings that urges the ball bearings outward relative to the input cam when the input cam rotates against the ball bearings. Of course, an input cam may have any suitable shape in other embodiments, as the present disclosure is not so limited. Accordingly, the ball bearings are moved into engagement with the plurality of inner detents once engaged with the detents, the ball bearings function to block the relative movement of the input cam 122 and the output gear 102 in the first direction. Accordingly, when the input cam is further rotated in the first direction, the output gear 102 is also driven in the first direction. Additionally, the ball bearings remain engaged with the same detent and orbit around the longitudinal axis of the clutch. As shown in FIG. 2B, the ball bearings are disposed on the slots 114 of the lag plate 110. Accordingly, the lag plate 110 is also rotated in the first direction and the input cam is driven in the first direction in the engaged state. As the lag plate 110 induces friction via the clamping spring 112, some frictional losses occur during powered drive of the output gear 102 by the input cam 122.

FIG. 2C is a front cross-sectional view of the clutch 100 of FIG. 2A in a third state. Relative to the second state shown in FIG. 2B, the input cam 122 shown in FIG. 2C has been rotated in a second direction opposite the first direction (e.g., counterclockwise relative to the page) to move the input cam to the disengaged state. In particular, the input cam has rotated in the second direction by 60+30 degrees, such that the first lobe 124A and the second lobe 124B are no longer engaged with the second ball bearing 106B and the first ball bearing 106A, respectively. Accordingly, the ball bearings now can move inward relative to the output gear 102 to disengage from the plurality of inner detents 104. As shown in FIG. 2C, movement of the input cam to the disengaged state from the engaged state does not necessarily disengage the ball bearings from the inner detents. Rather, the movement of the input cam to the disengaged state may merely allow the ball bearings to disengage from the inner detents. The process of disengaging the ball bearings from the inner detents is described further with reference to FIG. 2D. In some embodiments, the input cam 122 may include a magnetic shaft configured to magnetically attract the ball bearings inward out of engagement with the output gear 102. In such an embodiment, movement of the input cam to the disengaged state may also disengage the ball bearings from the inner detents.

FIG. 2D is a front cross-sectional view of the clutch 100 of FIG. 2A in a fourth state. FIG. 2D depicts a state in which the input cam 122 remains in a disengaged state and an external force is applied to the output gear 102. For example, FIG. 2D depicts a state where a user may apply a manual force to a deadbolt handle associated with the clutch. As shown in FIG. 2D, a force is applied to rotate the output gear 102 in the first direction (e.g., clockwise relative to the page). As the output gear is moved in the first direction, the ball bearings are pressed between the inner detents 104 and the slots 114 of the lag plate 110. As the lag plate is configured to generate a frictional force when rotated, the lag plate imparts this frictional force to the first ball bearing 106A and second ball bearing 106B to disengage the ball bearings from the inner detents 104, as shown by the dashed lines. The frictional force generated by the lag plate 110 may be above a threshold value to provide to enough resistive force against the rotation of the output gear 102 to move the ball bearings out of the inner detents. Once the ball bearings are moved inward toward the input cam 122 and out of engagement with the inner detents, the output gear 102 may rotate freely without resistance from either the lag plate 110 or input cam 122. While in FIG. 2D the output gear is rotated in the first direction, the output gear may also be rotated in the second direction to disengage the ball bearings from the inner detents 104. Accordingly, one the input cam is in the disengaged state, the output gear may be rotated manually in either the first direction or second direction and the ball bearings will disengage from the inner detents to allow free rotation of the output gear.

FIG. 2E is a front cross-sectional view of the clutch 100 of FIG. 2A in a fifth state. In the fifth state shown in FIG. 2E, the input cam 122 has been rotated to an engaged state relative to the state shown in FIG. 2D. However, in contrast to the process described with reference to FIGS. 2A-2B, the input cam in FIG. 2E has been rotated in the second direction (e.g., in a counterclockwise direction relative to the page) to the engaged state. Accordingly, the first lobe 124A has engaged the first ball bearing 106A and the second lobe 124B has engaged the second ball bearing 106B. As the input cam is rotated in the second direction, the first ball bearing 106A and second ball bearing 106B are pushed outward into engagement with the inner detents 104. Accordingly, once the ball bearings are engaged with the input cam as well as the inner detents, the input cam may be rotated in the second direction to correspondingly rotate the output gear 102 in the second direction. Thus, the clutch of FIGS. 2A-2E enables powered rotation of the output gear 102 in both the second direction and the first direction. Like the state of FIG. 2B, the lag plate 110 may be rotated by contact between the ball bearings and the slots 114 formed in the lag plate. Similar to powered rotation in the first direction, powered rotation in the second direction induces from frictional losses from the lag plate. FIG. 2F is a front cross-sectional view of the clutch 100 of FIG. 2A in a sixth state, which shows the rotation of the output gear 102 in the second direction while the input cam 122 is in the engaged state. That is, from the state shown in FIG. 2E, the state shown in FIG. 2F is accomplished by rotating the input cam (e.g., with a motor) in the second direction.

It should be noted that while a first direction refers to a clockwise direction relative to the page and a longitudinal axis of the clutch and a second direction refers to a counterclockwise direction relative to the page and a longitudinal axis of the clutch in the embodiment of FIGS. 2A-2F, the first direction and second direction may refer to any suitable rotation directions, as the present disclosure is not so limited. For example, the first direction may refer to a clockwise direction relative to a longitudinal axis of the clutch, and the second direction may refer to a counterclockwise direction relative to the longitudinal axis of the clutch.

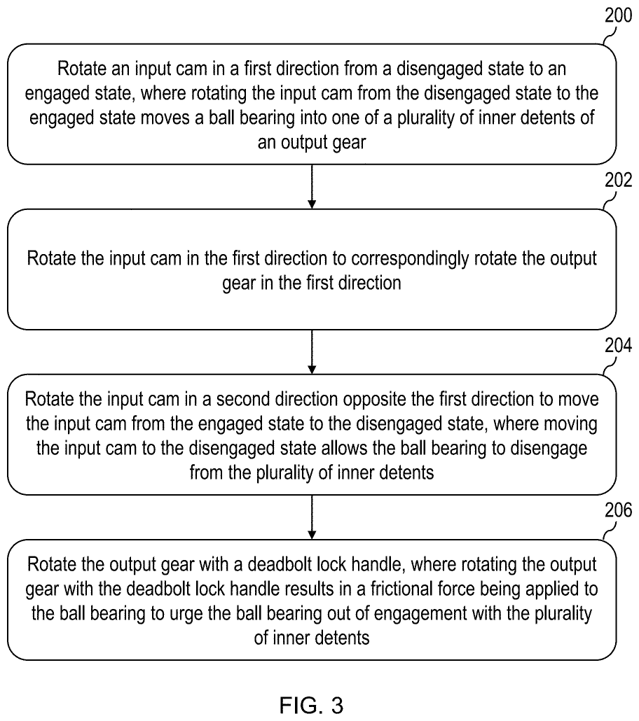

FIG. 3 is a flow chart for one embodiment of a method of operating a clutch according to exemplary embodiments described herein. In block 200, an input cam is rotated (e.g., by an input force applied by a motor or other actuator) in a first direction from a disengaged state to an engaged state. Rotating the input cam from the disengaged state to the engaged state moves a ball bearing into one of a plurality of inner detents of an output gear. That is, the shape of the input cam may urge the ball bearing outward relative to the input cam into engagement with the inner detents of the output gear. In block 202, the input cam is rotated in the first direction to correspondingly rotate the output gear in the first direction. As the input cam is rotated in the first direction in the engaged state, the input cam may continue to urge the ball bearing into engagement with the inner detents, and the ball bearing may transfer force between the input cam and the output gear. In some embodiments, the ball bearing may also rotate a lag plate of the clutch in the first direction when the input cam is rotated in the first direction in the engaged state.

In block 204, the input cam is rotated in a second direction opposite the first direction to move the input cam to the disengaged stated. Moving the input cam to the disengaged state allows the ball bearing to disengage from the plurality of inner detents. However, in some cases the ball bearings may remain engaged with the plurality of inner detents until an external force is applied to the output gear. In some embodiments, a motor or other actuator may apply an input force to rotate the input cam in the second direction to release the ball bearings. In some embodiments, the process in block 204 may be performed by the motor or other actuator every time the input cam is in the engaged state and the output gear is not being actively rotated by the motor or actuator. That is, the motor or actuator may be configured to move the input cam to the disengaged state whenever the motor or actuator is not driving the output gear.

Accordingly, in some embodiments, a processor or other circuit of the lock may be configured to operate the motor or actuator to follow a driving operation (e.g., that drives the bolt to the extended position or to the retracted position) with a supplemental disengagement operation that rotates the input cam in an opposite direction of the driving operation. In some such cases, the driving operation may be requested by a user input (e.g., a wireless instruction received by the lock) and they supplemental disengagement operation may not be requested by user input but the lock may be configured to perform the supplemental disengagement operation following the requested driving operation, or following each requested driving operation.

For example, if during the driving operation the motor or actuator drives the input cam in a first direction to perform the driving operation (to drive the bolt to the extended position or the retracted position) the motor or actuator, following completion of the driving operation, may be operated to drive the input cam in a second direction opposite the first direction. The amount by which the motor/actuator drives the input cam during the supplemental disengagement operation may be less than an amount the motor/actuator drives the input cam during a driving operation. The amount by which motor/actuator drives the input cam in the second direction may in some embodiments be configured to be enough for, given the arrangement of the lock, the input cam to disengage from the ball bearings and allow the ball bearings to drop out of the detents, and/or may be configured to be less than an amount that, given the arrangement of the lock, would cause the input cam to again engage the ball bearings and cause the ball bearings to engage the detents. In some embodiments, the amount by which the motor/actuator drives the input cam in the second direction may be enough to cause the input cam to rotate less than 90 degrees or less than 45 degrees in the second direction.

In block 206, the output gear is rotated with a deadbolt lock handle, where rotating the output gear with the deadbolt lock handle results in a frictional force being applied to the ball bearing to urge the bearing out of the plurality of inner detents. The output gear may be rotated in either the first direction or the second direction to apply the frictional force to the ball bearing to urge the ball bearing out of engagement with the inner detents.

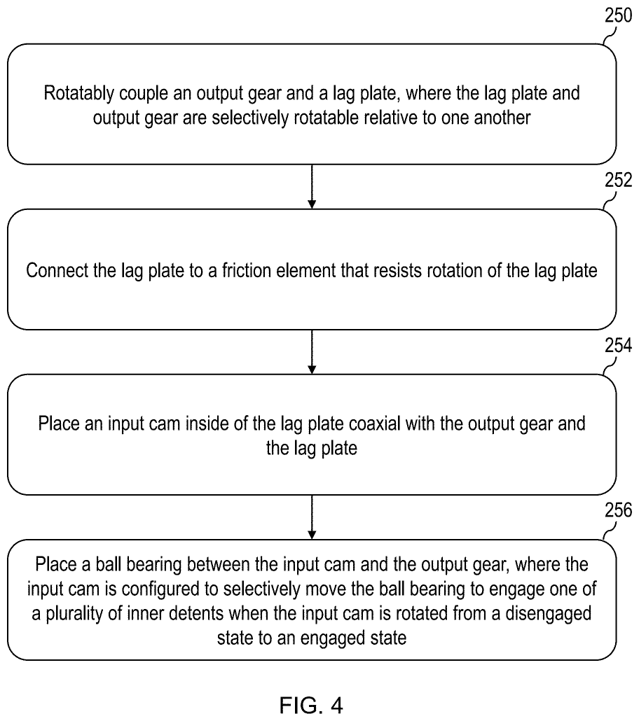

FIG. 4 is a flow chart for one embodiment of a method of manufacture for a clutch according to exemplary embodiments described herein. In block 250, an output gear is rotatably coupled to a lag plate, such that the lag plate and output gear may selectively rotate relative to one another. In block 252, the lag plate is connected to a friction element that resists rotation of the lag plate. In some embodiments, the friction element may be a bushing configured to generate frictional force above a threshold when the lag plate rotates. In some embodiments, the friction element may be a brake in contact with an exterior surface of the lag plate. In some embodiments, the friction element may be a clamping spring configured to apply a compression force to the lag plate, where the clamping spring is fixed to a housing associated with the clutch. Of course, any suitable friction element may be employed to resist rotation of the lag plate, as the present disclosure is not so limited. In block 254, an input cam is placed inside of the lag plate coaxial with the output gear and the lag plate. In input cam may also be selectively rotatable relative to both the output gear and the lag plate. In block 256, a ball bearing is placed between the input cam and the output gear. The input cam is configured to selectively move the ball bearing to engage one of a plurality of inner detents when the input cam is rotated from a disengaged state to an engaged state. In some embodiments, the method may also include playing a second ball bearing between the input cam and the output gear.

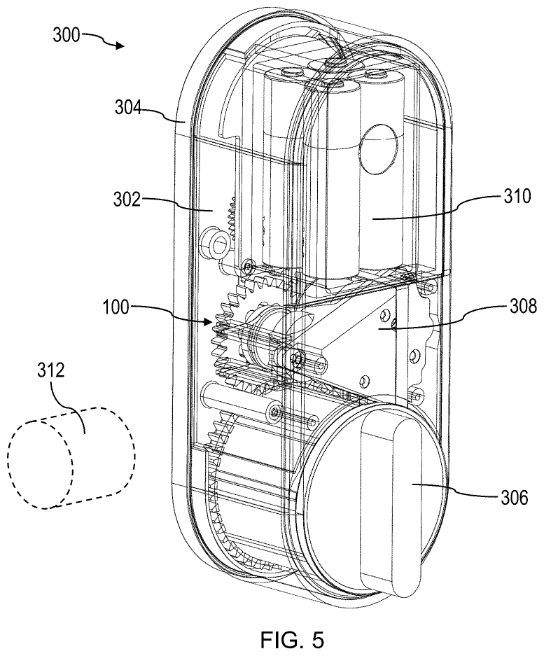

FIG. 5 is a perspective view of one embodiment of a door lock 300 including a clutch 100 according to exemplary embodiments described herein. The door lock 300 of FIG. 5 is configured to interface with a bolt 312 that is configured to move between an extended position and a retracted position when the door lock is in a locked state and unlocked state, respectively. As shown in FIG. 5, the door lock includes a housing 302, a mounting plate 304, a deadbolt handle 306, an actuator 308, and a power source 310. The housing encloses the actuator 308, power source 310, and clutch 100. The deadbolt handle 306 projects out of the housing and is rotatable by a user to correspondingly move the bolt 312 between the extended and retracted positions. The deadbolt handle 306 is coupled to both the bolt 312 and the clutch 100. In some embodiments, the deadbolt handle 306 is directly coupled to both the bolt 312 and the clutch 100. The actuator may be coupled to the handle and the bolt 312 indirectly through the clutch 100. As discussed previously, the clutch operates to selectively couple the actuator 308 to the bolt 312. When engaged, the clutch allows the actuator to rotate the deadbolt handle 306 and move the bolt 312 between the extended position and retracted position. When disengaged, the clutch allows the deadbolt handle 306 to rotate freely to move the bolt 312 without resistance from the actuator 308. The power source 310 is configured as batteries which provide electrical power to the actuator. The mounting plate 304 may be used to mount the housing 302 on an associated door. In some embodiments, the mounting plate 304 may be configured to mount to a preexisting deadbolt lock and may accordingly use preexisting mounting hardware so that the housing 302 may be secured to the door.

It should be noted that while exemplary embodiments described herein relate to door locks, a clutch according to embodiments herein may be employed in a wide range of applications to allow selective multi-directional powered rotation, and the present disclosure is not so limited in this regard.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A clutch for a door lock comprising:
an output gear including a plurality of inner detents;
a lag plate rotatable relative to the output gear and configured to generate friction when the lag plate rotates;
an input cam configured to be coupled to an output shaft of an actuator, wherein the input cam is configured to switch between an engaged state and a disengaged state; and
a ball bearing configured to:
when the input cam is in the engaged state, engage one of the plurality of inner detents to operatively couple the input cam to the output gear, and
when the input cam is in the disengaged state and the output gear is rotated by an external force, disengage from the plurality of inner detents under frictional force generated by the lag plate.

2. The clutch of claim 1, further comprising a second ball bearing configured to:
when the input cam is in the engaged state, engage one of the plurality of inner detents to operatively couple the input cam to the output gear, and
when the input cam is in the disengaged state and the output gear is rotated by an external force, disengage from the plurality of inner detents under frictional force generated by the lag plate.

3. The clutch of claim 1, wherein the lag plate includes a slot configured to receive the ball bearing when the input cam switches to the engaged state.

4. The clutch of claim 1, wherein the input cam is configured to rotate between the engaged state and the disengaged state.

5. The clutch of claim 4, wherein the engaged state and disengaged state are separated by an angular displacement between 30 and 90 degrees of rotation.

6. The clutch of claim 4, wherein the input cam is movable into the engaged state by rotating in either of two rotational directions.

7. The clutch of claim 1, wherein the output gear, lag plate, and input cam are coaxial.

8. The clutch of claim 1, wherein the lag plate includes a clamping spring configured to generate the friction when the lag plate rotates.

9. The clutch of claim 1, further comprising the actuator, wherein the output gear, lag plate, input cam, and actuator are coaxial.

10. (canceled)

11. The clutch of claim 1, wherein output gear is configured to be operatively coupled to a deadbolt lock such that rotation of the output gear moves the deadbolt lock.

12. The clutch of claim 11, wherein the output gear is configured to be operatively coupled to a deadbolt lock handle such that rotation of the output gear moves the deadbolt lock handle.

13. A door lock comprising:
a housing;
a deadbolt lock configured to move between a retracted position and an extended position;
a deadbolt lock handle operatively coupled to the deadbolt lock so that the deadbolt lock handle may be rotated to move the deadbolt lock between the retracted position and the extended position;
an output gear including a plurality of inner detents, wherein the output gear is operatively coupled to the deadbolt lock handle such that rotation of the output gear rotates the deadbolt lock handle;
an actuator including an output shaft;
a lag plate rotatable relative to the output gear and housing, wherein the lag plate is configured to generate frictional force when the lag plate rotates relative to the housing;
an input cam configured to be coupled to the output shaft of the actuator, wherein the input cam is configured to switch between an engaged state and a disengaged state; and
a ball bearing configured to:
when the input cam is in the engaged state, engage one of the plurality of inner detents to operatively couple the input cam to the output gear, and
when the input cam is in the disengaged state and the output gear is rotated by an external force, disengage from the plurality of inner detents under frictional force generated by the lag plate.

14. The door lock of claim 13, further comprising a second ball bearing configured to:
when the input cam is in the engaged state, engage one of the plurality of inner detents to operatively couple the input cam to the output gear, and
when the input cam is in the disengaged state and the output gear is rotated by an external force, disengage from the plurality of inner detents under frictional force generated by the lag plate.

15. The door lock of claim 13, wherein the lag plate includes a slot configured to receive the ball bearing when the input cam switches to the engaged state.

16. The door lock of claim 13, wherein the input cam is configured to rotate between the engaged state and the disengaged state.

17. The door lock of claim 16, wherein the engaged state and disengaged state are separated by an angular displacement between 30 and 90 degrees of rotation.

18. The door lock of claim 16, wherein the input cam is movable into the engaged state by rotating in either of two rotational directions.

19. The door lock of claim 13, wherein the actuator, output gear, lag plate, and input cam are coaxial.

20. The door lock of claim 13, wherein the lag plate includes a clamping spring coupled to the housing and configured to generate friction when the lag plate rotates relative to the housing.

21. (canceled)

22. A method of operating a door lock, the method comprising:
rotating an input cam in a first direction from a disengaged state to an engaged state, wherein rotating the input cam from the disengaged state to the engaged state moves a ball bearing into one of a plurality of inner detents of an output gear;
rotating the input cam in the first direction to correspondingly rotate the output gear in the first direction; and
rotating the input cam in a second direction opposite the first direction to move the input cam from the engaged state to the disengaged state, wherein moving the input cam to the disengaged state allows the ball bearing to disengage from the plurality of inner detents.

23-29. (canceled)
